(19) United States
(12) Patent Application Publication
(10) Pub. No.: US 2015/0244312 A1
(43) Pub. Date: Aug. 27, 2015

(54) POWER CONVERTER, SOLAR ENERGY DEVICE AND SOLAR ENERGY POWER CONVERSION METHOD

(71) Applicant: NEC CORPORATION, Tokyo (JP)

(72) Inventor: Shogo Nakaya, Tokyo (JP)

(73) Assignee: NEC Corporation, Tokyo (JP)

(21) Appl. No.: 14/432,980

(22) PCT Filed: Oct. 1, 2013
(86) PCT No.: PCT/JP2013/005841

§ 371 Date: Apr. 1, 2015

(30) Foreign Application Priority Data
Oct. 3, 2012 (JP) 2012-220999

(51) Int. Cl. H02S 40/34; H02S 40/22

(52) U.S. Cl. CPC H02S 40/34; H02S 40/22

(57) ABSTRACT

A power converter includes a plurality of converters, a control device, and a signal adjustment device. The converters are connected to the photoelectric conversion cells respectively. The control device generates a base signal based on electrical power output from at least one type of photoelectric conversion cell out of plurality types of photoelectric conversion cells. The base signal is a signal that is a base for a plurality of control signals to control the converters individually so that electrical power output from the photoelectric conversion cells reaches a maximum power point of each of the photoelectric conversion cells. The signal adjustment device multiplies the base signal by a constant, and supplies a signal generated by the multiplication by the constant, as the control signal, to the converter which is a signal supply destination.

### TECHNICAL FIELD

The present invention relates to a technology of power generation using solar light.

### BACKGROUND ART

FIG. 9 is a diagram describing an example of a solar energy device. The solar energy device is a condensation and stacked type solar energy device. The solar energy device includes a condenser lens 20B, a stacked photoelectric conversion cell 17, and an output device (power converter) 14D. The stacked photoelectric conversion cell 17 includes a plurality of photoelectric conversion cells 2, 3, and 4 and electrodes 15 and 16.

In the example in FIG. 9, the photoelectric conversion cells 2 to 4, the electrodes 15 and 16, and the condenser lens 20B are illustrated by a cross-sectional view taken along an optical axis 23 of the condenser lens 20B. The condenser lens 20B is a lens that condenses solar light which is incident in parallel with the optical axis 23. Each of the photoelectric conversion cells 2 to 4 has a function to convert light (solar light) to electricity. Sensitive wavelength bands of the photoelectric conversion cells 2 to 4 differ from one another. The photoelectric conversion cells 2 to 4 are stacked and connected electrically in series. The electrodes 15 and 16 are individually connected to both ends of a connected circuit which connects the photoelectric conversion cells 2 to 4 in series in such a way. A stacked photoelectric conversion cell 17 which is configured by the photoelectric conversion cells 2 to 4 and the electrodes 15 and 16 is arranged so that the light receiving surface is perpendicular to the optical axis 23 of the condenser lens 20B and positioned at the focal position of the condenser lens 20B.

The output device (power converter) 14D includes an electrical circuit to convert electrical energy, which is generated by the photoelectric conversion cells 2 to 4 and output from the electrodes 15 and 16, to electrical power with predetermined electrical characteristics (for example, a voltage with a predetermined voltage value and a current with a predetermined current value).

In such a solar energy device, solar light incident on the condenser lens 20B is transmitted through the condenser lens 20B and focuses on the light receiving surface of the stacked photoelectric conversion cell 17. This condensed light is transmitted through the photoelectric conversion cells 2 to 4 sequentially. Each of the photoelectric conversion cells 2 to 4 generates electricity by energy of light in the sensitive wavelength band. Because the sensitive wavelength bands of the photoelectric conversion cells 2 to 4 differ from one another as described above, the stacked photoelectric conversion cell 17 is able to carry out photoelectric conversion for a wide range of spectrum included in solar light. In other words, the condensation and stacked type solar energy device makes it possible to increase a conversion efficiency (photoelectric conversion efficiency) from solar energy to electrical energy.

The condensation and stacked type solar energy device has a problem such that it is difficult to achieve a further improvement in efficiency. That is, because the stacked photoelectric conversion cell 17 has a structure in which solar light is transmitted through the photoelectric conversion cells 2 to 4 sequentially, the solar light is attenuated when the solar light is transmitted through the photoelectric conversion cells 2 to 4. Thus, the amount of generated electrical power of the photoelectric conversion cell 4, which is positioned at a lower tier, becomes lower than the generated electrical power of the photoelectric conversion cell 2, which is positioned at a higher tier. The inventor has proposed various technologies concerning solar energy devices, and such proposals include a solar energy device that takes into account the above-described problem (for example, see PTL 1).

### CITATION LIST

### Patent Literature

[PTL 1] WO2011/074535 A1

### SUMMARY OF INVENTION

Technical Problem

In the condensation and stacked type solar energy device illustrated in FIG. 9, the photoelectric conversion cells 2 to 4 are, as described above, connected in series. As a consequence, due to electrical resistance at connecting portions in the photoelectric conversion cells 2 to 4 (boundary portions between cells), the electrical resistance of the photoelectric conversion cells 2 to 4 becomes high and thus the amount of current in the photoelectric conversion cells 2 to 4 is suppressed. Further, the photoelectric conversion cells 2 to 4 with different sensitive wavelength bands often have internal resistances differing from one another. In case that the photoelectric conversion cells 2 to 4 with different internal resistances are connected in series, the amount of current in the photoelectric conversion cells 2 to 4 is limited by the highest internal resistance among the internal resistances the photoelectric conversion cells 2 to 4 have. In consequence, a problem such that electrical power generated by the photoelectric conversion cells 2 to 4 is hard to be output sufficiently takes place.

The inventor has found that, for a solar energy device, there is a problem, including the above-described problem, such that electrical power is hard to be output efficiently because of a configuration related to outputting electrical energy.

A principal object of the present invention is to provide a technology by which electrical power generated by a photoelectric conversion cell can be output efficiently at low cost.

Solution to Problem

A power converter of the present invention includes
a plurality of converters each of which is connected to each of a plurality types of photoelectric conversion cells which have sensitive wavelength bands differing from one another and has a function to convert electrical power output from the photoelectric conversion cell connected;
a control device that, based on the output electrical power output from at least one type of photoelectric conversion cell among the plurality types of photoelectric conversion cells, generates a base signal from which a plurality of control signals are to be generated to control the plurality of converters individually so that electrical power output from the photoelectric conversion cell, which is a source of output of the output electrical power, reaches a maximum power point; and
a signal adjustment device that multiplies the base signal by a constant and supplies a signal generated by the constant multiplication, as the control signal, to the converter which is a signal supply destination.

A solar energy device of the present invention includes
a plurality types of photoelectric conversion cells with sensitive wavelength bands differing from one another; and
a power converter of the present invention.

A solar energy power conversion method includes
generating, based on an output electrical power output from at least one type of a photoelectric conversion cell among a plurality types of photoelectric conversion cells with sensitive wavelength band differing from one another, a base signal from which a plurality of control signals are to be generated to individually control a plurality of converters each of which is connected to each of the plurality types of photoelectric conversion cells so that electrical power output from the photoelectric conversion cell, which is a source of output of the output electrical power, reaches a maximum power point;
multiplying the base signal by a constant and supplying signal generated by the constant multiplication as the control signal to the converter which is signal supply destination, with respect to each the converter; and
converting and outputting electrical power output from the photoelectric conversion cells by the converters operating based on the control signals.

Advantageous Effects of Invention

According to the present invention, it is possible to output electrical power generated by a photoelectric conversion cell efficiently and at low cost.

### BRIEF DESCRIPTION OF DRAWINGS

FIG. 1 is a diagram illustrating a configuration of a power converter and a solar energy device including the power converter of a first exemplary embodiment according to the present invention in a simplified manner.

FIG. 2 is a diagram illustrating a configuration of a solar energy device of a second exemplary embodiment according to the present invention in a simplified manner.

FIG. 3 is a perspective view illustrating a photoelectric unit composing the solar energy device of the second exemplary embodiment schematically.

FIG. 4 is a circuit diagram describing a configuration of a power converter of the second exemplary embodiment.

FIG. 5 is a circuit diagram illustrating an example of a circuit configuration of a DC-DC converter.

FIG. 6 is a circuit diagram illustrating an example of another circuit configuration of the DC-DC converter.

FIG. 7 is a circuit diagram describing a power converter configuring a solar energy device of a third exemplary embodiment according to the present invention.

FIG. 8 is a diagram describing a configuration of a solar energy device of a fifth exemplary embodiment according to the present invention.

FIG. 9 is a diagram describing an example of a configuration of a solar energy device using a stacked photoelectric conversion cell.

### DESCRIPTION OF EMBODIMENTS

Exemplary embodiments according to the present invention will be described below with reference to the accompanying drawings.

### First Exemplary Embodiment

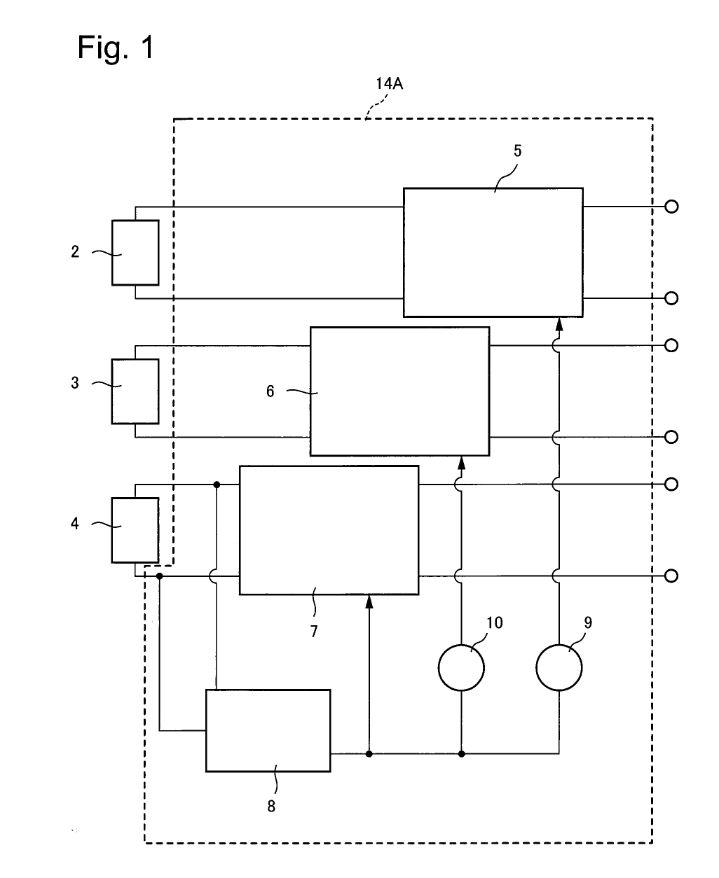

FIG. 1 is a model diagram illustrating, in a simplified manner, a configuration of a power converter and a solar energy device including the power converter of a first exemplary embodiment according to the present invention. The solar energy device of the first exemplary embodiment includes a plurality types of photoelectric conversion cells 2, 3, and 4 and a power converter 14A.

The photoelectric conversion cells 2 to 4 have a function to convert light (solar light energy) to electrical energy. Sensitive wavelength bands of the photoelectric conversion cells 2 to 4 differ from one another. The photoelectric conversion cells 2 to 4 are isolated electrically from one another.

The power converter 14A includes a plurality of converters 5, 6, and 7, a control device 8, and signal adjustment devices 9 and 10.

The converter 5, the converter 6, and the converter 7 are connected to the photoelectric conversion cell 2, the photoelectric conversion cell 3, and the photoelectric conversion cell 4, respectively. In other words, each of the converters 5 to 7 is connected to a type of photoelectric conversion cell, which differs from the others, out of the plurality types of photoelectric conversion cells 2 to 4. The converters 5 to 7 have a function to convert electrical power output from the connected photoelectric conversion cells 2 to 4 to electrical power with predefined electrical characteristics (for example, a voltage with a predefined voltage value and a current with a predefined current value).

The control device 8 has a function to generate a base signal based on electrical power output from at least one type of photoelectric conversion cell out of the plurality types of photoelectric conversion cells 2 to 4. The base signal is a signal that is a base for a plurality of control signals to control the converters 5 to 7 individually so that electrical power output from the photoelectric conversion cells 2 to 4 reaches a maximum power point (MPP) of each of the photoelectric conversion cells 2 to 4. In the example in FIG. 1, the control device 8 has a function to generate a signal (control signal), as the base signal, to control the converter 7 so that electrical power output from the photoelectric conversion cell 4 reaches a maximum power point of the photoelectric conversion cell 4 based on the electrical power output from the photoelectric conversion cell 4.

Each of the signal adjustment devices 9 and 10 multiplies the base signal by a constant, and supplies a signal generated by the multiplication by the constant, as a control signal, to the converter 5 or the converter 6, which is a signal supply destination. Specifically, in the example in FIG. 1, the signal adjustment device 9 multiplies the base signal by a constant and supplies a signal generated by the multiplication by the constant, as the control signal, to the converter 5. The constant by which the base signal is multiplied is, for example, a constant depending on a ratio of a characteristic value of the photoelectric conversion cell 4, which is a source of output of the electrical power applied to the control device 8 to generate the base signal, to a characteristic value of the photoelectric conversion cell 2, which is connected to the converter 5 (signal supply destination). The signal adjustment device 10 multiplies the base signal by a constant and supplies a signal generated by the multiplication by the constant to the converter 6 as a control signal. The constant by which the base signal is multiplied is, for example, a constant depending on a ratio of a characteristic value of the photoelectric conversion cell 4, which is a source of output of the electrical power the control device 8 uses to generate the base signal, to a characteristic value of the photoelectric conversion cell 3, which is connected to the converter 6 (signal supply destination). In the example illustrated in FIG. 1, because the base signal generated by the control device 8 is supplied to the converter 7 as a control signal without any change, no signal adjustment device, which is similar to the above-described signal adjustment device, for the converter 7 is included.

The solar energy device of the first exemplary embodiment has the following advantageous effects. Specifically, in the first exemplary embodiment, the plurality of photoelectric conversion cells 2 to 4 are isolated from one another, and each of the photoelectric conversion cells 2 to 4 outputs electrical power (electrical power is extracted). Thus, it is possible to prevent a problem that takes place in case that electrical power is extracted from a plurality of photoelectric conversion cells which are connected electrically in series as described above. That is, the solar energy device of the first exemplary embodiment makes it possible to prevent electrical power loss at connection (boundary) portions of photoelectric conversion cells. The solar energy device also makes it possible to prevent a problem such that, among internal resistances of a plurality of photoelectric conversion cells, the highest internal resistance limits a current which flows through the photoelectric conversion cells. Accordingly, the solar energy device of the first exemplary embodiment provides an advantageous effect such that it is possible to extract (output) electrical power from the plurality of photoelectric conversion cells 2 to 4 efficiently.

In addition, in the first exemplary embodiment, the control device 8 of the power converter 14A, as described above, has a function to generate a signal to control the converters 5 to 7 so that electrical power from the photoelectric conversion cells 2 to 4 reaches the maximum power point. In other words, the control device 8 has a function as a maximum power point tracking device. Although the configuration of the maximum power point tracking device is complicated, the power converter 14A of the first exemplary embodiment has an advantageous effect such that it is not necessary to implement such the complicated maximum power point tracking device (control device 8) to each of the converters 5 to 7. With this configuration, it is possible to simplify the configurations of the power converter 14A and the solar energy device including the power converter 14A. The power converter 14A and the solar energy device including the power converter 14A also make it possible to reduce cost thereof.

Accordingly, the power converter 14A and the solar energy device including the power converter 14A of the first exemplary embodiment provide an advantageous effect such that electrical power generated by the photoelectric conversion cells 2 to 4 is output efficiently at low cost.

### Second Exemplary Embodiment

A second exemplary embodiment according to the present invention will be described below.

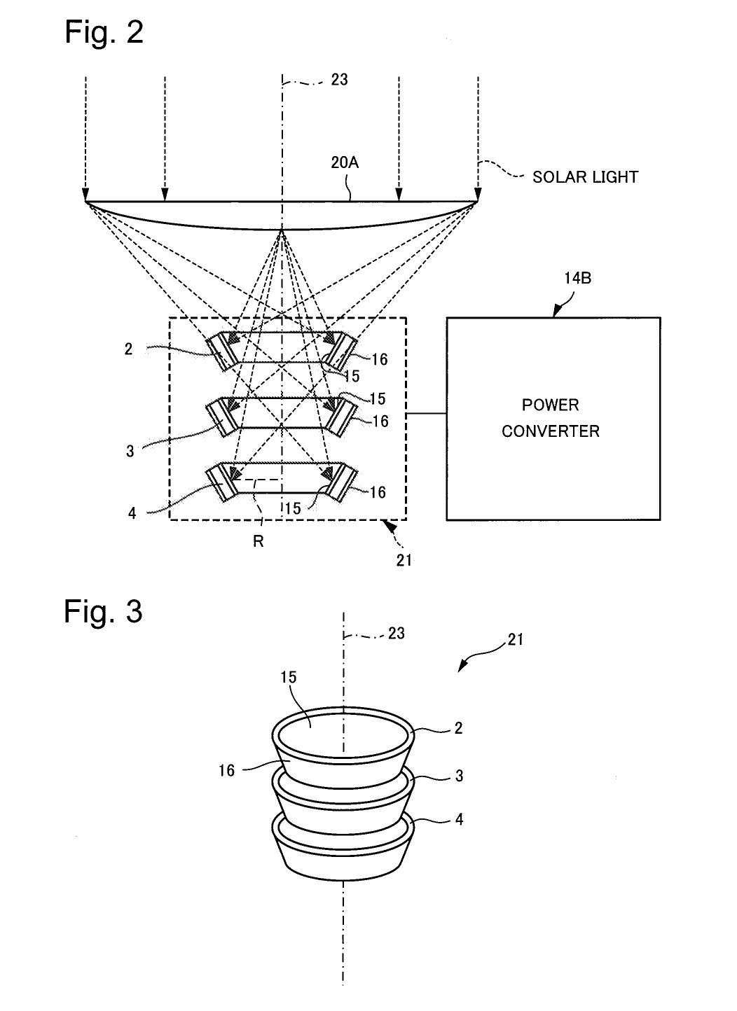

FIG. 2 is a model diagram illustrating, in a simplified manner, a configuration of a solar energy device of the second exemplary embodiment according to the present invention. The solar energy device of the second exemplary embodiment includes a condenser lens 20A, a photoelectric unit 21, and a power converter 14B. In FIG. 2, the condenser lens 20A and the photoelectric unit 21 are illustrated by a cross section taken along an optical axis 23 of the condenser lens 20A.

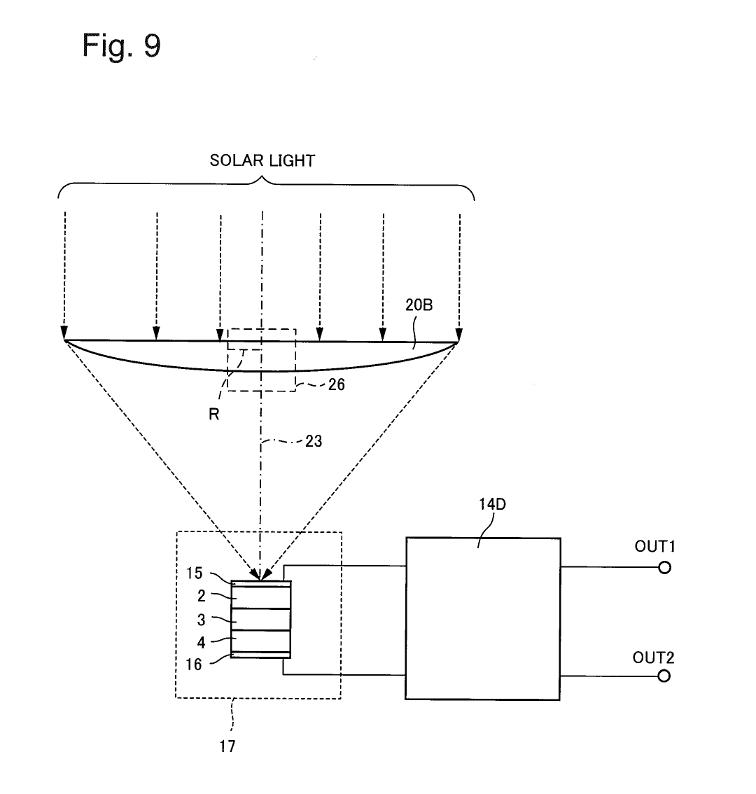

The condenser lens 20A has a function to condense light (solar light) which is incident in parallel with the optical axis 23 of the condenser lens 20A and a spectral decomposition function. The cross section of the condenser lens 20A and the cross section of the condenser lens 20B illustrated in FIG. 9 excluding a region 26 within a radius R around the optical axis 23 are in a similarity relation. The condenser lens 20A focuses light in a shape of ring with a radius R around the optical axis 23. Actually, the condenser lens 20A focuses light at a position shifted in the direction away from the condenser lens 20A for each wavelength band as the wavelength of light lengthens due to chromatic aberration.

FIG. 3 is a perspective view illustrating the photoelectric unit 21 schematically. The photoelectric unit 21 includes a plurality of photoelectric conversion cells 2, 3, and 4. The photoelectric conversion cells 2 to 4, as described in the first exemplary embodiment, have a function to convert light (solar light) energy to electrical energy. The photoelectric conversion cells 2 to 4 are isolated from one another. The sensitive wavelength bands of the photoelectric conversion cells 2 to 4 also differ from one another.

Specifically, the photoelectric conversion cell 2 sensitively responds to light in a short wavelength band to generate electrical energy. The photoelectric conversion cell 3 sensitively responds to light in a middle wavelength band to generate electrical energy. The photoelectric conversion cell 4 sensitively responds to light in a long wavelength band to generate electrical energy.

The configuration of each of the photoelectric conversion cells 2 to 4, as illustrated in FIG. 3, is a rotating body around the optical axis 23. The photoelectric conversion cell 2 is arranged so that a light receiving surface thereof is positioned at a ring-shaped focal position of short wavelength band light of the condenser lens 20A. The photoelectric conversion cell 3 is arranged so that a light receiving surface thereof is positioned at a ring-shaped focal position of middle wavelength band light of the condenser lens 20A. The photoelectric conversion cell 4 is arranged so that a light receiving surface thereof is positioned at a ring-shaped focal position of long wavelength band light of the condenser lens 20A.

In the second exemplary embodiment, each of the photoelectric conversion cells 2 to 4 directly receives light in each wavelength band which is transmitted through the condenser lens 20A. Thus, the photoelectric unit 21 makes it possible to prevent a problem such that attenuated light is received as in the stacked photoelectric conversion cell 17 illustrated in FIG. 9.

In the second exemplary embodiment, each of the photoelectric conversion cells 2 to 4 includes electrodes 15 and 16. With this configuration, electrical energy is extracted (output) from each of the photoelectric conversion cells 2 to 4 for each of the photoelectric conversion cells 2 to 4. Accordingly, the photoelectric unit 21 makes it possible to remedy a problem caused by the photoelectric conversion cells 2 to 4 being connected in series (a problem such that electrical energy is hard to be extracted efficiently).

The solar energy device of the second exemplary embodiment is sometimes referred to as a multi-junction solar energy device because the solar energy device includes the photoelectric unit 21 as described above.

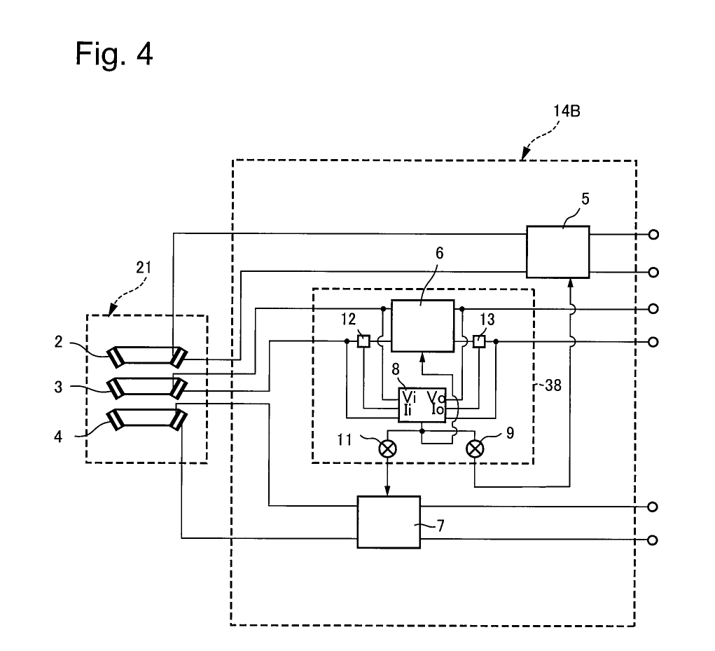

FIG. 4 is a circuit diagram illustrating a circuit configuration of the power converter 14B. The power converter 14B includes a plurality of converters 5, 6, and 7, a control device 8, a plurality of signal adjustment devices 9 and 11, and current sensors 12 and 13.

Each of the converters 5 to 7 is connected to a photoelectric conversion cell which is different from the others out of the photoelectric conversion cells 2 to 4. The converters 5 to 7 are DC (Direct Current)-DC (Direct Current) converters in the second exemplary embodiment. That is, the converters 5 to 7 have a function to convert DC power output from the photoelectric conversion cells 2 to 4 connected thereto to DC power with predetermined electrical characteristics (for example, a predetermined current value or a predetermined voltage value).

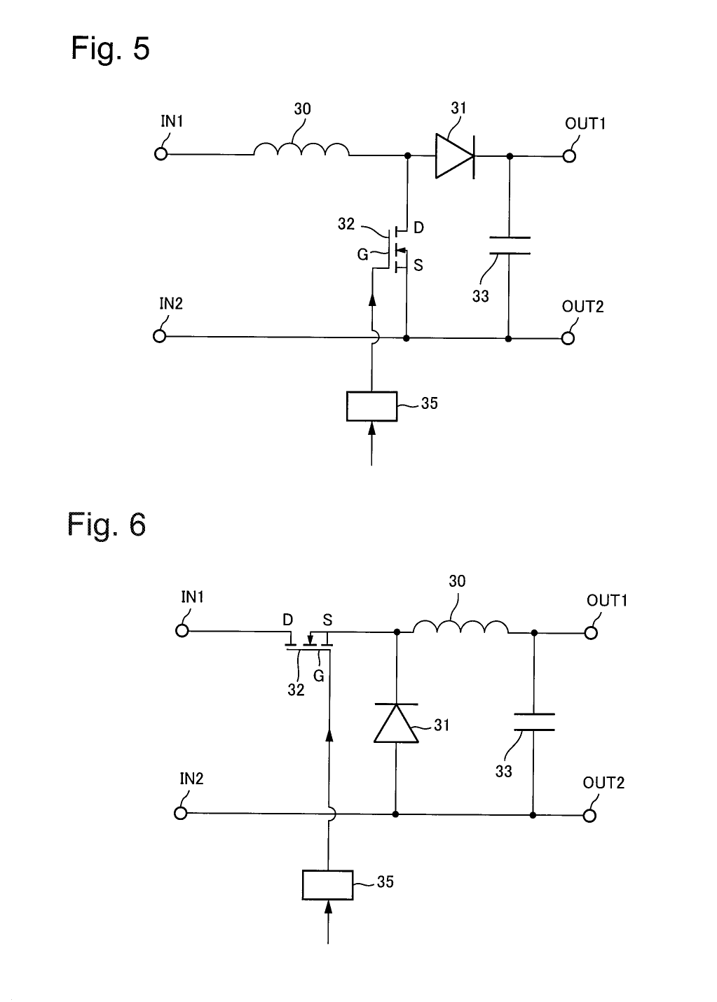

FIG. 5 is a circuit diagram illustrating an example of a circuit configuration of the DC-DC converter. The DC-DC converter is a boost converter which outputs electrical power with a higher voltage than an input voltage. The DC-DC converter includes an inductor 30, a diode 31, a switching element 32, a capacitor 33, and a control circuit 35.

The switching element 32 is configured with, for example, a MOS (Metal-Oxide-Semiconductor) transistor. The MOS transistor is an element that switches between a state (ON-state) in which a current flows between the source (S) and the drain (D) and a state (OFF-state) in which no current flows therebetween depending on a switching control signal (digital pulse signal formed by logical values of 0 and 1) which is applied to the gate (G) thereof.

The control circuit 35 has a function to generate the switching control signal supplied to the switching element 32. The control circuit 35 also has a function to control a duty ratio of the switching control signal by the PWM (Pulse Width Modulation) control by using a control signal (analog signal) applied from the control device 8 (signal adjustment devices 9 and 11). The duty ratio is a ratio between the width of a pulse with a logical value of 1 and the width of a pulse with a logical value of 0 in the switching control signal.

Changes in the duty ratio of the switching control signal cause changes in the length of a period during which the switching element 32 is in ON-state. With this configuration, the amount of current which flows through the circuit of the DC-DC converter changes, leading to changes in the voltage and current of the electrical power output from output sections OUT1 and OUT2 of the DC-DC converter. In other words, the control circuit 35 is a circuit that controls the output electrical power of the DC-DC converter.

FIG. 6 is a circuit diagram illustrating another example of the circuit configuration of the DC-DC converter. The DC-DC converter is a step-down converter that outputs electrical power with a lower voltage than an input voltage. The DC-DC converter is configured with an inductor 30, a diode 31, a switching element 32, a capacitor 33, and a control circuit 35. The switching element 32 is configured with a MOS transistor. The control circuit 35, in a similar manner to the control circuit 35 illustrated in FIG. 5, has a function to control a duty ratio of a switching control signal, which is supplied to the switching element 32, by the PWM control by using a control signal (analog signal) applied from the control device 8 (signal adjustment devices 9 and 11). That is, the control circuit 35 is a circuit that controls the output electrical power of the DC-DC converter.

Each of the converters 5 to 7 includes the circuit of the DC-DC converter as described above. Circuit configurations employed for the converters 5 to 7 are not limited to the circuit configurations illustrated in FIGS. 5 and 6, and may be circuit configurations other than the circuit configurations illustrated in FIGS. 5 and 6 as long as output electrical power from a photoelectric conversion cell can be converted to electrical power with predetermined electrical characteristics.

The current sensor 12 illustrated in FIG. 4 is a sensor that detects an amount of current input to the converter 6 and outputs a signal with a value proportional to the amount of the input current. The current sensor 13 is a sensor that detects an amount of current output from the converter 6 and outputs a signal with a value proportional to the amount of the output current.

The control device 8 is a device that has a function as a maximum power point tracking control device. In other words, the control device 8 has a function to generate a control signal (control signal applied to the control circuit 35 of the DC-DC converter) to control the converter 6 so as to be able to extract electrical power at a maximum power point from the photoelectric conversion cell 3. Various algorithms to generate the control signal have been proposed. For example, one of such algorithms is the P&O (Perturb and Observe) method. In the P&O method, the control device 8, for example, increases or decreases the control signal (analog signal) value which is output to the control circuit 35 of the converter 6. The control device 8 then senses an input voltage Vi which is input to the converter 6 from the photoelectric conversion cell 3, an output voltage Vo which is output from the converter 6, and a signal Ii which is output from the current sensor 12 and carries out multiplication between the current and the voltage based on the sensed values. With this operation, the control device 8 calculates (estimates) output electrical power output from the photoelectric conversion cell 3 and observes (monitors) the calculated output electrical power. With this operation, in case that the control device 8 detects that the output electrical power has changed in the increasing direction, the control device 8 changes the value of the control signal further in the increasing direction or the decreasing direction, that is, in the same direction as described above. On the other hand, in case that the control device 8 detects that the output electrical power has changed in the decreasing direction, the control device 8 changes the value of the control signal further in the decreasing direction or the increasing direction, that is, in the opposite direction to the description above. By repeating such operations, the control device 8 continues tracking the maximum power point so that the output electrical power from the photoelectric conversion cell 3 reaches the maximum power point. The control device 8 uses a voltage and a signal depending on an employed algorithm out of the input voltage Vi which is input to the converter 6, the output voltage Vo which is output from the converter 6, and signals Ii and Io which are output from the current sensors 12 and 13.

In the second exemplary embodiment, the signal (analog signal) generated by the control device 8 is a base signal that is a base for a plurality of control signals to control each of the converters 5 to 7. In other words, in the second exemplary embodiment, the signal (base signal) generated by the control device 8 is applied to the control circuit 35 of the converter 6 as a control signal without any change. Further, the signal is applied to the control circuit 35 of the converter 5 via the signal adjustment device 9. Furthermore, the signal is applied to the control circuit 35 of the converter 7 via the signal adjustment device 11.

The signal adjustment devices 9 and 11 have a circuit configuration (multiplier) which multiplies the base signal output by the control device 8 by a constant. The constant by which the signal adjustment device 9 multiplies the base signal is a value depending on a ratio of a characteristic value of the photoelectric conversion cell 3 to a characteristic value of the photoelectric conversion cell 2. The constant by which the signal adjustment device 11 multiplies the base signal is a value depending on a ratio of a characteristic value of the photoelectric conversion cell 3 to a characteristic value of the photoelectric conversion cell 4. That is, the photoelectric conversion cells 2 to 4 have sensitive wavelength bands differing from one another and characteristic values such as internal resistances which differ from one another depending on the sensitive wavelength bands. It is possible to acquire such characteristic values of the photoelectric conversion cells 2 to 4 in advance. The maximum power point of the photoelectric conversion cells 2 to 4 varies depending on a sunshine condition, an ambient temperature around the photoelectric conversion cells 2 to 4, and load variation at the output ends which are connected to the photoelectric conversion cells 2 to 4, and so on. However, it is possible to regard that a ratio among optimum operating voltages at which the photoelectric conversion cells 2 to 4 individually output electrical power at the maximum power points takes substantially the same value, although each maximum power point varies.

Regarding what is described above, the power converter 14B is also able to track the maximum power points of the photoelectric conversion cells 2 and 4 by using the control signals calculated by multiplying the base signal generated by the control device 8 by constants depending on ratios of characteristic values. In other words, in the second exemplary embodiment, the power converter 14B is able to track not only the maximum power point of the photoelectric conversion cell 3 but also the maximum power points of the photoelectric conversion cells 2 and 4 by using the control signal (base signal) to control the converter 6.

In the second exemplary embodiment, the converter 6, the control device 8, the signal adjustment devices 9 and 11, and the current sensors 12 and 13 configure a power converter 38.

The power converter 14B and the solar energy device including the power converter 14B of the second exemplary embodiment, as described above, have a configuration that does not require an implementation of a control device that generates the control signal to track the maximum power point of each of the photoelectric conversion cells 2 to 4 with respect to each of the converters 5 to 7. Thus, because the solar energy device of the second exemplary embodiment, as with the solar energy device of the first exemplary embodiment, makes it possible to reduce the number of implementations of the control device 8 compared with a case in which the same number of the control devices 8 as the number of implementations of the converters 5 to 7 are implemented, it is possible to achieve a cost reduction. It is also possible to simplify the configurations of the power converter 14B and the solar energy device including the power converter 14B.

### Third Exemplary Embodiment

A third exemplary embodiment according to the present invention will be described below. In the description of the third exemplary embodiment, a component with a name identical to the name of a component of the solar energy device of the second exemplary embodiment will be denoted by the same sign, and overlapping description of such a common component will be omitted.

In the third exemplary embodiment, the control device 8 detects not only a current and a voltage output from the photoelectric conversion cell 3 but also currents and voltages output from photoelectric conversion cells 2 and 4 and monitors output electrical power from a plurality (all) of photoelectric conversion cells 2 to 4. The control device 8 generates the control signal (base signal) to control the converter 6 so that a total value or a mean value of the plurality (all) of output electrical power values is maximized.

In the solar energy device of the third exemplary embodiment, the configuration of a portion other than the above-described control device 8 is the same as the configuration in the second exemplary embodiment, and description thereof will be omitted in this description.

A power converter 14B and the solar energy device including the power converter 14B of the third exemplary embodiment are able to provide a similar advantageous effect to the advantageous effect of the second exemplary embodiment. In the third exemplary embodiment, the control device 8 generates the control signal (base signal) by using the total value or the mean value of output electrical power values from the plurality (all) of photoelectric conversion cells 2 to 4. Thus, the power converter 14B and the solar energy device including the power converter 14B of the third exemplary embodiment make it possible to output more electrical power from a photoelectric unit 21 as a whole.

### Fourth Exemplary Embodiment

A fourth exemplary embodiment according to the present invention will be described below. In the description of the fourth exemplary embodiment, a component with a name identical to the name of components of the solar energy devices of the second and third exemplary embodiments will be denoted by the same sign, and overlapping description of such a common component will be omitted.

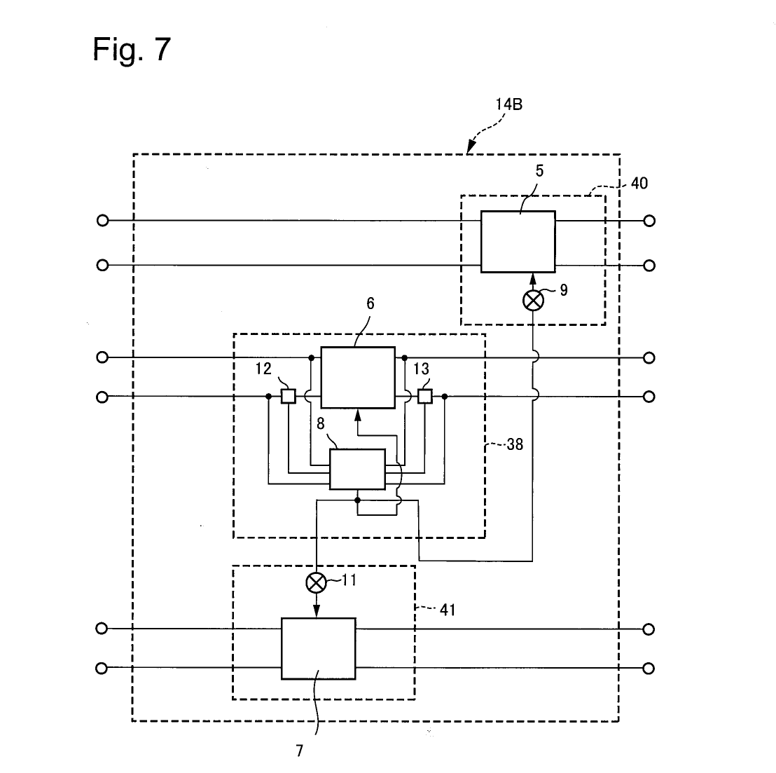

In the second and third exemplary embodiments described above, the signal adjustment devices 9 and 11 are integrated with the converter 6 and the control device 8 into a single device to configure the power converter 38. On the other hand, in the fourth exemplary embodiment, as illustrated in FIG. 7, the signal adjustment device 9 is integrated into a single device 40 with the converter 5. The signal adjustment device 11 is integrated into a single device 41 with the converter 7. FIG. 7 is a circuit diagram illustrating a configuration of the power converter 14B in a simplified manner, and illustration of the condenser lens 20A and the photoelectric unit 21 is omitted.

In the solar energy device of the fourth exemplary embodiment, the configuration of a portion other than the above-described portion is the same as the configuration in the second and third exemplary embodiments, and description thereof will be omitted in this description.

The power converter 14B and the solar energy device including the power converter 14B of the fourth exemplary embodiment are also able to provide a similar advantageous effect to the advantageous effect of the second and third exemplary embodiments.

### Fifth Exemplary Embodiment

A fifth exemplary embodiment according to the present invention will be described below. In the description of the fifth exemplary embodiment, a component with a name identical to the name of components of the solar energy devices of the second to fourth exemplary embodiments will be denoted by the same sign, and overlapping description of such a common component will be omitted.

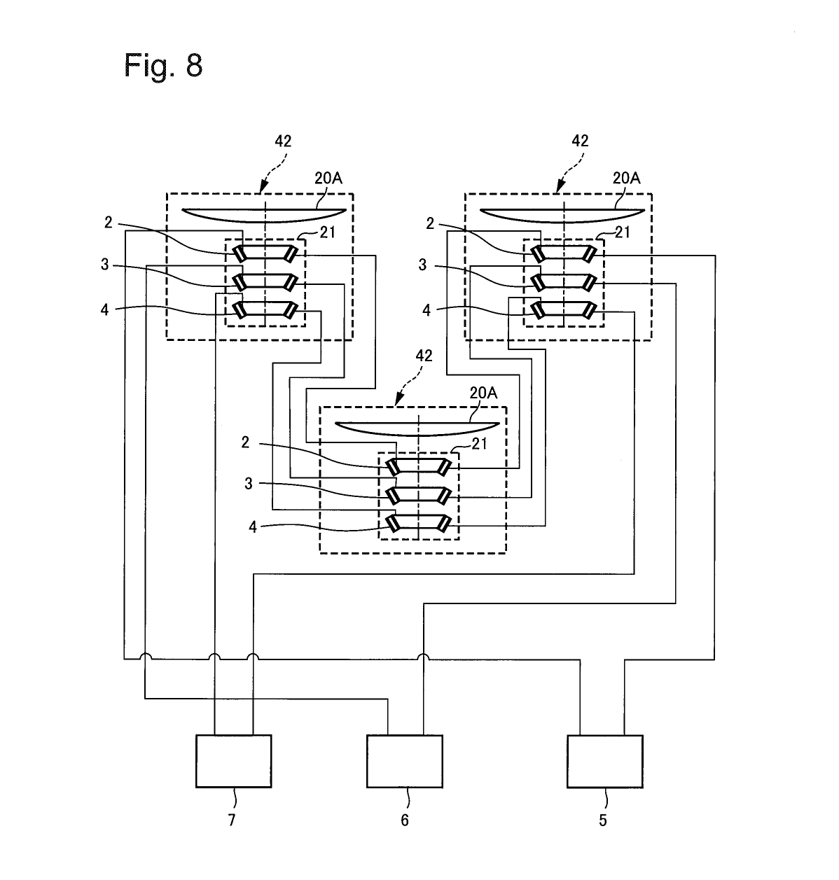

A solar energy device of the fifth exemplary embodiment, as illustrated in FIG. 8, includes a plurality of photoelectric conversion units 42. Each of the photoelectric conversion unit 42 includes the condenser lens 20A and the photoelectric unit 21. The photoelectric conversion cells 2 with the same sensitive wavelength band, the photoelectric conversion cells 3 with the same sensitive wavelength band, and the photoelectric conversion cells 4 with the same sensitive wavelength band in the photoelectric conversion units 42 are electrically interconnected in series or in parallel, respectively. In FIG. 8, a case in which photoelectric conversion cells with the same sensitive wavelength band are interconnected in series is illustrated.

The photoelectric conversion cells 2 with the same sensitive wavelength band, the photoelectric conversion cells 3 with the same sensitive wavelength band, and the photoelectric conversion cells 4 with the same sensitive wavelength band, while being interconnected electrically as described above, are connected to a corresponding shared converter 5, a corresponding shared converter 6, and a corresponding shared converter 7, respectively. That is, the plurality of photoelectric conversion cells 2, which are suitable for light in the short wavelength band, are connected to the shared converter 5. The plurality of photoelectric conversion cells 3, which are suitable for light in the middle wavelength band, are connected to the shared converter 6. The plurality of photoelectric conversion cells 4, which are suitable for light in the long wavelength band, are connected to the shared converter 7.

The configuration of a portion other than the above-described portion is the same as the configuration described in any one of the second to fourth exemplary embodiments. That is, in the fifth exemplary embodiment, the control device 8 that generates the base signal, which is the base for control signals to control the converters 5 to 7 individually, is implemented. The signal adjustment devices 9 and 11, which generate control signals suitable for the converters 5 and 7, which are signal supply destinations, by multiplying the base signal by constants, are also implemented.

Because, in the fifth exemplary embodiment, the power converter and the solar energy device including the power converter have the configuration similar to the configurations of the second to fourth exemplary embodiments, the power converter and the solar energy device including the power converter of the fifth exemplary embodiment make it possible to achieve an advantageous effect similar to the advantageous effects of the power converters and the power generation apparatuses including the power converters of the second to fourth exemplary embodiments.

### Sixth Exemplary Embodiment

A sixth exemplary embodiment according to the present invention will be described below. In the description of the sixth exemplary embodiment, a component with a name identical to the name of components of the solar energy devices of the second to fifth exemplary embodiments will be denoted by the same sign, and overlapping description of such a common component will be omitted.

A solar energy device of the sixth exemplary embodiment has a configuration in which constants by which the signal adjustment devices 9 and 11 multiply the base signal are changed depending on a predetermined condition. Specifically, a ratio among characteristic values of the photoelectric conversion cells 2 to 4 changes gradually due to a gradual change in a condition (environment) caused by diurnal motion and annual motion of the sun or the like. In the sixth exemplary embodiment, the gradual change in the ratio among the characteristic values of the photoelectric conversion cells 2 to 4 is taken into consideration. That is, the control device 8 has a function to output, to the signal adjustment devices 9 and 11, an instruction to change (update) the constants by which the signal adjustment devices 9 and 11 multiply the base signal depending on the gradual change in the ratio among the characteristic values of the photoelectric conversion cells 2 to 4 as describe above. The signal adjustment devices 9 and 11 change (update) the constants by which the base signal is multiplied based on the instruction.

The configuration of a portion other than the portion described above is the same as the configurations of the second to fifth exemplary embodiments, and description of the portion will be omitted in this description.

The power converter and the solar energy device including the power converter of the sixth exemplary embodiment also provide an advantageous effect similar to the advantageous effects of the second to fifth exemplary embodiments.

### Other Exemplary Embodiments

The present invention is not limited to the configurations of the first to sixth exemplary embodiments and may have various embodiments. For example, in each of the second to sixth exemplary embodiments, the control device 8 and the converter 6 configure the power converter 38. In substitution for this configuration, the control device 8 may configure a power converter including the converter 5 or the converter 7.

In the second exemplary embodiment, the control device 8 generates the base signal based on information on electrical power input/output to/from the converter 6, such as the input voltage and the input current input to the converter 6 and the output voltage and the output current output from the converter 6. In substitution for this configuration, the control device 8 may generate the base signal based on information on electrical power input/output to/from the converter 5 and the converter 7.

Furthermore, in each of the first to sixth exemplary embodiments, the solar energy device includes three types of the photoelectric conversion cells 2 to 4, each of which corresponds to each of three wavelength bands. It is sufficient for the solar energy device to have, in substitution for this configuration, a plurality types of the photoelectric conversion cells each of which corresponds to one of two or more wavelength bands, and thus the solar energy device may have two types of the photoelectric conversion cells each of which corresponds to each of two kinds of wavelength bands, or may have four or more types of the photoelectric conversion cells each of which corresponds to each of four or more kinds of wavelength bands.

Moreover, although, in each of the second to sixth exemplary embodiments, a plurality types of the photoelectric conversion cells have the configuration illustrated in

FIG. 3, the configuration of the photoelectric conversion cell is not limited to the configuration in FIG. 3.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2012-220999, filed on Oct. 3, 2012, the disclosure of which is incorporated herein in its entirety by reference.

### INDUSTRIAL APPLICABILITY

The present invention provides a solar power generation technology and is supposed to be usable in various fields related to energy.

### REFERENCE SIGNS LIST

2, 3, 4 Photoelectric conversion cell

5, 6, 7 Converter

8 Control device

9, 10, 11 Signal adjustment device

14A, 14B, 14D Power converter

20A, 20B Condenser lens

What is claimed is:

1. A power converter comprising:
a plurality of converters each of which is connected to each of a plurality types of photoelectric conversion cells which have sensitive wavelength bands differing from one another and has a function to convert electrical power output from the photoelectric conversion cell connected;
a control device that, based on the output electrical power output from at least one type of photoelectric conversion cell among the plurality types of photoelectric conversion cells, generates a base signal from which a plurality of control signals are to be generated to control the plurality of converters individually so that electrical power output from the photoelectric conversion cell, which is a source of output of the output electrical power, reaches a maximum power point; and
a signal adjustment device that multiplies the base signal by a constant and supplies a signal generated by the constant multiplication, as the control signal, to the converter which is a signal supply destination.

2. The power converter according to claim 1, wherein the control device generates the base signal so that a total value or a mean value of electrical power output from the plurality types of photoelectric conversion cells takes a maximum value.

3. The power converter according to claim 1, wherein the constant by which the signal adjustment device multiplies the base signal is determined based on a ratio of a characteristic value of the photoelectric conversion cell that is a source of output of electrical power the control device uses in generation of the base signal to a characteristic value of the photoelectric conversion cell that is connected to the converter which is an output destination to which the signal adjustment device outputs the control signal.

4. The power converter according to claim 1, wherein the signal adjustment device changes the constant by which the base signal is multiplied depending on a predetermined condition.

5. The power converter according to claim 4, wherein the signal adjustment device changes the constant by which the base signal is multiplied in response to a variation which is slower than a variation of the control signal.

6. The power converter according to claim 1, wherein the control device is integrated into a single device with one of the converters.

7. The power converter according to claim 1, wherein the signal adjustment device is integrated into a single device with the converter which is the signal supply destination.

8. A solar energy device comprising:
a plurality types of photoelectric conversion cells with sensitive wavelength bands differing from one another; and
a power converter according to claim 1.

9. The solar energy device according to claim 8, further comprising:
a condenser lens that forms a focus in a ring shape around an optical axis, the focus being spectrally decomposed due to a chromatic aberration,
wherein each of the plurality types of photoelectric conversion cells is arranged at a position of the focus corresponding to the sensitive wavelength band of the photoelectric conversion cell.

10. A solar energy power conversion method comprising:
generating, based on an output electrical power output from at least one type of a photoelectric conversion cell among a plurality types of photoelectric conversion cells with sensitive wavelength band differing from one another, a base signal from which a plurality of control signals are to be generated to individually control a plurality of converters each of which is connected to each of the plurality types of photoelectric conversion cells so that electrical power output from the photoelectric conversion cell, which is a source of output of the output electrical power, reaches a maximum power point;
multiplying the base signal by a constant and supplying signal generated by the constant multiplication as the control signal to the converter which is signal supply destination, with respect to each the converter; and
converting and outputting electrical power output from the photoelectric conversion cells by the converters operating based on the control signals.
